(19) United States
(12) Patent Application Publication
(10) Pub. No.: US 2026/0204034 A1
(43) Pub. Date: Jul. 16, 2026

(54) IMAGE RENDERING METHOD AND APPARATUS, DEVICE, AND STORAGE MEDIUM

(71) Applicant: Beijing Zitiao Network Technology Co., Ltd., Beijing (CN)

(72) Inventor: Ruchong LUO, Beijing (CN)

(21) Appl. No.: 19/131,883

(22) PCT Filed: Nov. 17, 2023
(86) PCT No.: PCT/CN2023/132276

§ 371 Date: May 21, 2025

(30) Foreign Application Priority Data
Nov. 22, 2022 (CN) 202211469457.8

(51) Int. Cl. G06T 19/20

(52) U.S. Cl. CPC G06T 19/20; G06T 2219/2016

(57) ABSTRACT

Embodiments of the present disclosure provide an image rendering method, a device, and a storage medium. The method includes: obtaining a three dimensional (3D) virtual model, and receiving initial transformation information input by a user; performing transformation of a first projection type and transformation of a second projection type on the 3D virtual model respectively based on the initial transformation information to obtain a first projection model and a second projection model; and controlling the 3D virtual model to translate in a screen coordinate system based on the first projection model and the second projection model to obtain a target image.

### CROSS-REFERENCE TO RELATED APPLICATIONS

The present disclosure is a U.S. National Stage Application of International Patent Application No. PCT/CN2023/132276, filed on Nov. 17, 2023, which claims priority of the Chinese Patent Application No. 202211469457.8, filed on Nov. 22, 2022, the entire disclosures of which are incorporated herein by reference as part of the present application.

### TECHNICAL FIELD

Embodiments of the present disclosure relate to an image rendering method and apparatus, a device, and a storage medium.

### BACKGROUND

When perspective projection is performed on a three dimensional (3D) virtual model, the effect that distant objects appear smaller than nearer objects due to perspective is presented. Since pose information of a virtual camera remains unchanged during the perspective projection process, when the projected virtual model moves, the virtual model may undergo deformation. Deformation of the virtual model may affect the image display effect, making an image unnatural.

### SUMMARY

Embodiments of the present disclosure provide an image rendering method and apparatus, a device, and a storage medium, which can prevent a projected virtual model from undergoing deformation during movement, making the display of the projected virtual model more natural, thereby improving the image display effect.

According to a first aspect, an embodiment of the present disclosure provides an image rendering method. The method includes:
obtaining a three dimensional (3D) virtual model, and receiving initial transformation information input by a user, where the 3D virtual model is composed of a plurality of vertices, and the transformation information includes at least one of scaling information, rotation information, and translation information;
performing transformation of a first projection type and transformation of a second projection type on the 3D virtual model respectively based on the initial transformation information, to obtain a first projection model and a second projection model; and
controlling the 3D virtual model to translate in a screen coordinate system based on the first projection model and the second projection model, to obtain a target image.

According to a second aspect, an embodiment of the present disclosure further provides an image rendering apparatus. The apparatus includes:
an initial transformation information obtaining module, configured to obtain a three dimensional (3D) virtual model, and receive initial transformation information input by a user, where the 3D virtual model is composed of a plurality of vertices, and the transformation information includes at least one of scaling information, rotation information, and translation information;
a projection transformation module, configured to perform transformation of a first projection type and transformation of a second projection type on the 3D virtual model respectively based on the initial transformation information, to obtain a first projection model and a second projection model; and
a target image obtaining module, configured to control the 3D virtual model to translate in a screen coordinate system based on the first projection model and the second projection model, to obtain a target image.

According to a third aspect, an embodiment of the present disclosure further provides an electronic device. The electronic device includes:
one or more processors; and
a storage apparatus, configured to store one or more programs, where the one or more programs, when executed by the one or more processors, cause the one or more
processors to implement the image rendering method according to the embodiment of the present disclosure.

According to a fourth aspect, an embodiment of the present disclosure further provides a storage medium containing computer-executable instructions, where the computer-executable instructions, when executed by a computer processor, are used to perform the image rendering method according to the embodiment of the present disclosure.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of an image rendering method according to an embodiment of the present disclosure;

FIG. 2a is an exemplary diagram of rendering 3D text according to an embodiment of the present disclosure;

FIG. 2b is an exemplary diagram of rendering 3D text using a technology according to an embodiment of the present disclosure;

FIG. 2c is an exemplary diagram of rendering a 3D object according to an embodiment of the present disclosure;

FIG. 2d is an exemplary diagram of rendering a 3D object using a technology according to an embodiment of the present disclosure;

FIG. 3 is a schematic diagram of a structure of an image rendering apparatus according to an embodiment of the present disclosure; and

FIG. 4 is a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

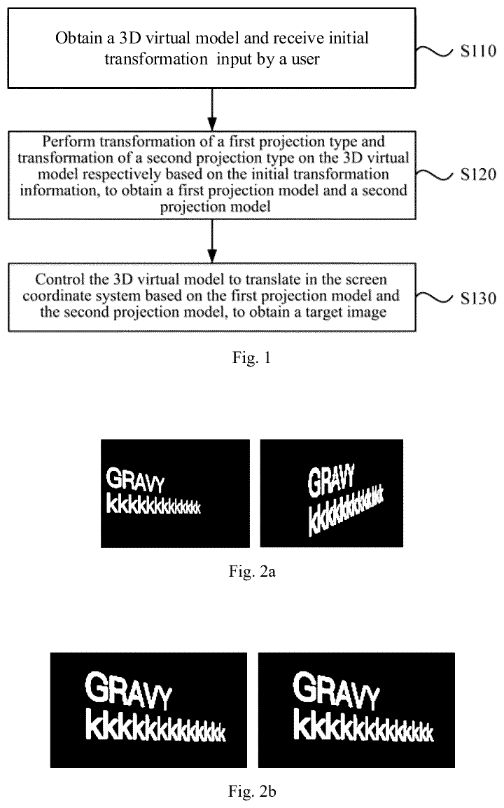

FIG. 1 is a schematic flowchart of an image rendering method according to an embodiment of the present disclosure. This embodiment of the present disclosure is applicable to a case that a 3D virtual model is rendered as a 2D image. The method may be performed by an image rendering apparatus. The apparatus may be implemented in the form of software and/or hardware. Optionally, the apparatus may be implemented by an electronic device, which may be a mobile terminal, a PC, a server, or the like.

As shown in FIG. 1, the method includes the following steps.

S110: Obtain a 3D virtual model and receive initial transformation information input by a user.

The 3D virtual model is composed of a plurality of vertices, and the initial transformation information includes at least one of scaling information, rotation information, and translation information. The vertices of the 3D virtual model are represented by three-dimensional coordinates in a local space coordinate system of the model. The 3D virtual model may be understood as a pre-constructed virtual model of a 3D object, where the 3D object may be any object, such as an object, a human body, or text, which is not limited herein.

The scaling information may be composed of scaling amounts along the X, Y, and Z axes, the rotation information may be composed of rotation amounts around the X, Y, and Z axes, and the translation information may be composed of translation amounts along the X, Y, and Z axes. In this embodiment, the initial transformation information may be represented by a transformation matrix (model matrix). Specifically, the process of obtaining initial transformation information input by a user may be: first, receiving any one of the scaling information, the rotation information, and the translation information that are input by the user, then, determining a scaling matrix based on the scaling information, determining a rotation matrix based on the rotation information, and determining a translation matrix based on the translation information, and finally, multiplying the scaling matrix, the rotation matrix, and the translation matrix sequentially, to obtain an initial transformation matrix, this is, the initial transformation information.

S120: Perform transformation of a first projection type and transformation of a second projection type on the 3D virtual model respectively based on the initial transformation information to obtain a first projection model and a second projection model.

The first projection type may be perspective projection, and the second projection type may be orthogonal projection. The perspective projection may be understood as projecting a 3D object onto a projection plane using a central projection method, so as to obtain a single-sided projection image closer to a visual effect. The orthogonal projection may be understood as a projection where a projection line is perpendicular to the projection plane.

In this embodiment, the process of performing projection transformation on the 3D virtual model based on the initial transformation information may be: first, obtaining projection information and view information, then, determining projection transformation information based on the initial transformation information, the projection information, and the view information, and finally, performing projection transformation on the 3D virtual model based on the projection transformation information.

The projection information represents a transformation relationship from a camera coordinate system to a screen coordinate system, and the view information represents a transformation relationship from a world coordinate system to the camera coordinate system. The camera coordinate system is a coordinate system where a virtual camera is located, and the world coordinate system is a coordinate system where the 3D virtual model is located. The projection transformation information may be represented by a model view projection (MVP) matrix, the transformation information may be represented by a transformation matrix (model matrix), the view information may be represented by a view matrix, and the projection information may be represented by a projection matrix. The manner of determining projection transformation information based on the initial transformation information, the projection information, and the view information may be: multiplying the projection matrix, the view matrix, and the initial transformation matrix sequentially, to obtain the MVP matrix. The manner of performing projection transformation on the 3D virtual model based on the projection transformation information may be multiplying the MVP matrix by four-dimensional coordinates of each vertex of the 3D virtual model, to obtain a projection model. For example, a calculation formula of the projection model may be expressed as: Position1=P*V*M*Position0, where Position1 represents the coordinates of vertices in the projection model, P represents the projection matrix, V represents the view matrix, M represents the transformation matrix, and Position0 represents the coordinates of the vertices in the 3D virtual model.

In this embodiment, the view matrix may be determined by preset virtual camera parameters, where the virtual camera parameters may include an optical center position and a field of view of the camera. The projection information is determined by near-plane and far-plane parameters of the virtual camera. For perspective projection, a perspective projection matrix may be expressed as:

$$[ \begin{matrix}\frac{2 n}{r - l} & 0 & \frac{r + l}{r - l} & 0 \\ 0 & \frac{2 n}{t - b} & \frac{t + b}{t - b} & 0 \\ 0 & 0 & \frac{- ( f + n )}{f - n} & \frac{- 2 fn}{f - n} \\ 0 & 0 & - 1 & 0\end{matrix} ] ,$$

and for orthogonal projection, an orthogonal projection matrix may be expressed as:

$$[ \begin{matrix}\frac{2}{r - l} & 0 & 0 & - \frac{r + l}{r - l} \\ 0 & \frac{2}{t - b} & 0 & - \frac{t + b}{t - b} \\ 0 & 0 & \frac{- 2}{f - n} & - \frac{- f - n}{f - n} \\ 0 & 0 & 0 & 1\end{matrix} ] ,$$

where n is the z-coordinate of a near plane, f is the z-coordinate of a far plane, t and b are the y-coordinates of the upper and lower sides of the near plane respectively, and 1 and r are the x-coordinates of the left and right sides of the near plane respectively.

Optionally, the manner of performing transformation of a first projection type on the 3D virtual model based on the initial transformation information to obtain a first projection model may be: obtaining perspective projection information and view information; adjusting the translation information in the initial transformation information, to obtain first transformation information; and performing perspective projection transformation on the 3D virtual model based on the first transformation information, the perspective projection information, and the view information to obtain a perspective projection model as the first projection model.

The perspective projection information is represented by the perspective projection matrix determined in the above embodiment, and the view information is represented by the view matrix determined in the above embodiment. The manner of adjusting the translation information in the initial transformation information, to obtain first transformation information may be: determining a first adjustment amount based on the translation information in the initial transformation information, and a first set value; and adjusting the translation information based on the first adjustment amount, to obtain the first transformation information.

The first set value is 0 or a value close to 0. Specifically, the adjusting the translation information in the initial transformation information may be understood as: adjusting an x component and a y component in the translation information in the initial transformation information. The determining a first adjustment amount based on the translation information in the initial transformation information, and a first set value may be understood as: subtracting the translation information from the first set value, to obtain the first adjustment amount. The adjusting the translation information based on the first adjustment amount may be understood as: accumulating the translation information with the first adjustment amount. In this embodiment, the initial transformation information is represented by the transformation matrix, and a size of the transformation matrix is 4*4. The x component in the translation information is in the first row and fourth column, and the y component is in the second row and fourth column. That is, values of the first row and fourth column, and the second row and fourth column in the transformation matrix are adjusted based on the first set value.

Specifically, the process of performing perspective projection transformation on the 3D virtual model based on the first transformation information, the perspective projection information, and the view information is: multiplying the perspective projection matrix corresponding to the perspective projection information, the view matrix corresponding to the view information, and the transformation matrix corresponding to the first transformation information sequentially, to obtain a perspective transformation matrix, and multiplying the perspective transformation matrix by the four-dimensional coordinates of each vertex in the 3D virtual model, to obtain a perspective projection model. In this embodiment, each vertex in the perspective projection model is represented by a four-dimensional vector, which may be expressed, for example, as pos1=(x1, y1, z1, w1). In this embodiment, when perspective projection transformation is performed on the 3D virtual model, the translation information in the transformation matrix is adjusted based on the first set value, making the perspective projection less affected by the translation information, thereby reducing the deformation during the translation of the 3D virtual model.

Optionally, the manner of performing transformation of a second projection type on the 3D virtual model based on the initial transformation information, to obtain a second projection model may be: obtaining orthogonal projection information and view information; adjusting the rotation information and the scaling information in the initial transformation information to obtain second transformation information; and performing orthogonal projection transformation on the 3D virtual model based on the second transformation information, the orthogonal projection information, and the view information to obtain an orthogonal projection model as the second projection model.

The orthogonal projection information represents an orthogonal transformation relationship from the camera coordinate system to the screen coordinate system, and the view information represents a transformation relationship from the world coordinate system to the camera coordinate system. The camera coordinate system is a coordinate system where the virtual camera for rendering is located, and the world coordinate system is a coordinate system where the 3D virtual model is located. The orthogonal projection information is represented by the orthogonal projection matrix determined in the above embodiment, and the view information is represented by the view matrix determined in the above embodiment. The manner of adjusting the rotation information and the scaling information in the initial transformation information, to obtain second transformation information may be: determining a second adjustment amount based on the rotation information in the initial transformation information, and a second set value; determining a third adjustment amount based on the scaling information in the initial transformation information, and a third set value; and adjusting the rotation information based on the second adjustment amount, and adjusting the scaling information based on the third adjustment amount, to obtain the second transformation information.

The second set value is 0 or a value close to 0, and the third set value is 1 or a value close to 1. Specifically, the determining a second adjustment amount based on the rotation information in the initial transformation information and a second set value may be understood as: subtracting the rotation information from the second set value to obtain the second adjustment amount. The adjusting the rotation information based on the second adjustment amount may be understood as: accumulating the second adjustment amount with the rotation information. In this embodiment, the initial transformation information is represented by the transformation matrix, and a size of the transformation matrix is 4*4. If components in the first row and second column, the first row and third column, the second row and first column, the second row and third column, the third row and first column, and the third row and second column are six components of the rotation information, the six components are adjusted based on the second set value. Optionally, in this embodiment, the six components may be directly adjusted to 0. The determining a third adjustment amount based on the scaling information in the initial transformation information, and a third set value may be understood as: subtracting the scaling information from the third set value, to obtain the third adjustment amount. The adjusting the scaling information based on the third adjustment amount may be understood as: accumulating the third adjustment amount with the scaling information.

The scaling information includes a scaling amount along the x-axis, a scaling amount along the y-axis, and a scaling amount along the z-axis. In this embodiment, if the scaling amount along the x-axis is in the first row and first column, the scaling amount along the y-axis is in the second row and second column, and the scaling amount along the z-axis is in the third row and third column, the three amounts are adjusted based on the third set value. Optionally, the three amounts may be directly adjusted to 1.

Specifically, the process of performing orthogonal projection transformation on the 3D virtual model based on the second transformation information, the orthogonal projection information, and the view information, to obtain an orthogonal projection model may be: multiplying the orthogonal projection matrix corresponding to the orthogonal projection information, the view matrix corresponding to the view information, and the transformation matrix corresponding to the second transformation information sequentially, to obtain an orthogonal transformation matrix, and multiplying the orthogonal transformation matrix by the four-dimensional coordinates of each vertex in the 3D virtual model, to obtain an orthogonal projection model. In this embodiment, each vertex in the orthogonal projection model is represented by a four-dimensional vector, which may be expressed, for example, as pos2=(x2, y2, z2, w2). In this embodiment, when orthogonal projection transformation is performed on the 3D virtual model, the rotation information in the transformation matrix is adjusted based on the second set value, and the scaling information is adjusted based on the third set value, which can reduce the impact of the rotation information and the scaling information on orthogonal projection.

S130: Control the 3D virtual model to translate in the screen coordinate system based on the first projection model and the second projection model to obtain a target image.

Translation may be understood as only changing the position of the 3D virtual model in the screen coordinate system without changing its shape.

Specifically, the manner of controlling the 3D virtual model to translate in the screen coordinate system based on the first projection model and the second projection model, to obtain a target image may be: fusing the first projection model and the second projection model, to obtain a target projection model; and rendering the target projection model, to obtain the target image.

In this embodiment, the fusing the first projection model and the second projection model may be understood as: fusing coordinates of the corresponding vertices of the first projection model and the second projection model, to obtain fused vertex coordinates, where fused vertices constitute the target projection model.

Specifically, the manner of fusing the first projection model and the second projection model, to obtain the target projection model may be: extracting vertex coordinate from the first projection model; and performing linear superimposition on the second projection model and the first projection model based on the vertex coordinate to obtain the target projection model.

The vertex coordinates of the first projection model are represented by four-dimensional coordinates, which are an x component, a y component, a z component, and a w component respectively. The process of performing linear superimposition on the second projection model and the first projection model based on the vertex coordinates may be: multiplying the w component of the vertex coordinates of the first projection model by vertex coordinates of the second projection model, and accumulating a multiplication result with the vertex coordinates of the first projection model, to obtain the target projection model. For example, assuming that the vertex coordinates of the first projection model are expressed as: pos1=(x1, y1, z1, w1), and the vertex coordinates of the second projection model are expressed as pos2=(x2, y2, z2, w2), a formula of fusing the first projection model and the second projection model may be expressed as: POS=pos1+pos2*w1, where POS represents the vertex coordinates of the target projection model, that is, POS=(x1+x2*w1, y1+y2*w1, z1+z2*w1, w1+w2*w1). In this embodiment, by fusing the first projection model after perspective projection and the second projection model after orthogonal projection, it can be ensured that the target projection model after fusion only undergoes translation in the screen coordinate system, without deformation during the movement process.

In this embodiment, the rendering the target projection model may be understood as: rendering the target projection model as a 2D image.

Each vertex of the target projection model is represented by four-dimensional coordinate, including: a first component, a second component, a third component, and a fourth component. The first component is the x component, the second component is the y component, the third component is the z component, and the fourth component is the w component. Specifically, the manner of rendering the target projection model, to obtain the target image may be: performing homogeneous transformation on the vertex coordinates of the target projection model; and rendering the target projection model after homogeneous transformation, to obtain the target image.

The process of performing homogeneous transformation on the vertex coordinates of the target projection model may be understood as: dividing the vertex coordinates of the target projection model by the fourth component (i.e., the w component). For example, assuming that the vertex coordinates of the target projection model are expressed as: POS=(x1+x2*w1, y1+y2*w1, z1+z2*w1, w1+w2*w1), the vertex coordinates of the target projection model after homogeneous transformation change to ((x1+x2*w1)/(w1+w2*w1), (y1+y2*w1)/(w1+w2*w1), (z1+z2*w1)/(w1+w2*w1), 1). In this embodiment, by performing homogeneous transformation on the vertex coordinates of the target projection model, the accuracy of the subsequent rendering can be improved.

Optionally, the manner of rendering the target projection model after homogeneous transformation, to obtain the target image may be: extracting two components corresponding to the screen coordinate system from a vertex coordinate of the target projection model after homogeneous transformation; and rendering the 3D virtual model to the screen coordinate system based on the two components to obtain the target image.

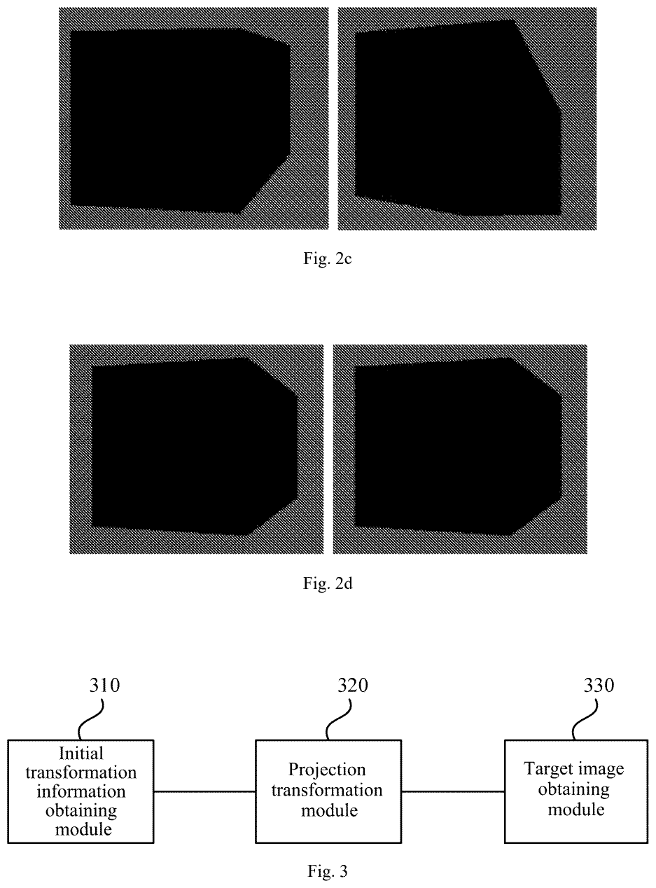

The two components corresponding to the screen coordinate system are the x component and the y component respectively. Specifically, the x component and the y component are extracted from the vertex coordinates of the target projection model after homogeneous transformation, the x component and the y component constitute position information of the vertices of the target projection model in the screen coordinate system, and finally, pixel values of the vertices of the target projection model are rendered to corresponding positions in the screen coordinate system, so as to obtain the target image. In this embodiment, the 3D virtual model can be accurately rendered to the screen coordinate system based on the two components corresponding to the screen coordinate system. For example, FIG. 2a is an exemplary diagram of rendering 3D text, where the left diagram is an image before the 3D text is moved, and the right diagram is an image after the 3D text is moved. Comparing the left and right diagrams, it can be seen that the 3D text undergoes obvious deformation, making the display of the 3D text unnatural. FIG. 2b is an exemplary diagram of rendering 3D text using a technology, where the left diagram is an image before the 3D text is moved, and the right diagram is an image after the 3D text is moved. Comparing the left and right diagrams, it can be seen that the 3D text does not undergo obvious deformation, making the display of the 3D text more natural and improving the display effect. FIG. 2c is an exemplary diagram of rendering a 3D object, where the left diagram is an image before the 3D object is moved, and the right diagram is an image after the 3D object is moved. Comparing the left and right diagrams, it can be seen that the 3D object undergoes obvious deformation, making the display of the 3D object unnatural. FIG. 2d is an exemplary diagram of rendering a 3D object using a technology, where the left diagram is an image before the 3D object is moved, and the right diagram is an image after the 3D object is moved. Comparing the left and right diagrams, it can be seen that the 3D object does not undergo obvious deformation, making the display of the 3D object more natural and improving the display effect. Optionally, the 3D virtual model in this embodiment may alternatively be any object, for example, a human, an animal, or a plant, which is not limited in this embodiment.

According to the technical solutions of the embodiments of the present disclosure, the 3D virtual model is obtained, and the initial transformation information input by the user is received, where the 3D virtual model is composed of the plurality of vertices, and the initial transformation information includes at least one of the scaling information, the rotation information, and the translation information; transformation of the first projection type and transformation of the second projection type are performed on the 3D virtual model respectively based on the initial transformation information, to obtain the first projection model and the second projection model; and the 3D virtual model is controlled to translate in the screen coordinate system based on the first projection model and the second projection model, to obtain the target image. In the image rendering method provided in the embodiments of the present disclosure, transformation of two projection types is performed on the 3D virtual model, to control the 3D virtual model to translate in the screen coordinate system based on the first projection model and second projection model after transformation. It can be ensured that the virtual model projected onto the screen coordinate system only undergoes translation without deformation during movement, making the display of the projected virtual model more natural, thereby improving the image display effect.

FIG. 3 is a schematic diagram of a structure of an image rendering apparatus according to an embodiment of the present disclosure. As shown in FIG. 3, the apparatus includes:
an initial transformation information obtaining module 310, configured to obtain a 3D virtual model, and receive initial transformation information input by a user, where the 3D virtual model is composed of a plurality of vertices, and the initial transformation information includes at least one of scaling information, rotation information, and translation information;
a projection transformation module 320, configured to perform transformation of a first projection type and transformation of a second projection type on the 3D virtual model respectively based on the initial transformation information to obtain a first projection model and a second projection model; and
a target image obtaining module 330, configured to control the 3D virtual model to translate in a screen coordinate system based on the first projection model and the second projection model to obtain a target image.

Optionally, the first projection type is perspective projection, and the projection transformation module 320 is further configured to:
obtain perspective projection information and view information, where the perspective projection information represents a perspective transformation relationship from a camera coordinate system to the screen coordinate system, and the view information represents a transformation relationship from a world coordinate system to the camera coordinate system, and the camera coordinate system is a coordinate system where a virtual camera for rendering is located, and the world coordinate system is a coordinate system where the 3D virtual model is located;
adjust the translation information in the initial transformation information, to obtain first transformation information; and
perform perspective projection transformation on the 3D virtual model based on the first transformation information, the perspective projection information, and the view information to obtain a perspective projection model as the first projection model.

Optionally, the projection transformation module 320 is further configured to:
determine a first adjustment amount based on the translation information in the initial transformation information, and a first set value; and
adjust the translation information based on the first adjustment amount to obtain the first transformation information.

Optionally, the second projection type is orthogonal projection, and the projection transformation module 320 is further configured to:
obtain orthogonal projection information and view information, where the orthogonal projection information represents an orthogonal transformation relationship from the camera coordinate system to the screen coordinate system, and the view information represents a transformation relationship from the world coordinate system to the camera coordinate system, and the camera coordinate system is a coordinate system where the virtual camera for rendering is located, and the world coordinate system is a coordinate system where the 3D virtual model is located;
adjust the rotation information and the scaling information in the initial transformation information, to obtain second transformation information; and
perform orthogonal projection transformation on the 3D virtual model based on the second transformation information, the orthogonal projection information, and the view information to obtain an orthogonal projection model as the second projection model.

Optionally, the projection transformation module 320 is further configured to:
determine a second adjustment amount based on the rotation information in the initial transformation information, and a second set value;
determine a third adjustment amount based on the scaling information in the initial transformation information, and a third set value; and
adjust the rotation information based on the second adjustment amount, and adjust the scaling information based on the third adjustment amount, to obtain the second transformation information.

Optionally, the target image obtaining module 330 is further configured to:
fuse the first projection model and the second projection model, to obtain a target projection model; and
render the target projection model, to obtain the target image.

Optionally, the target image obtaining module 330 is further configured to:
extract vertex coordinates from the first projection model; and
perform linear superimposition on the second projection model and the first projection model based on the vertex coordinates, to obtain the target projection model.

Optionally, vertex coordinates of the target projection model are represented by a four-dimensional coordinate, including: a first component, a second component, a third component, and a fourth component.

The target image obtaining module 330 is further configured to:
perform homogeneous transformation on the vertex coordinates of the target projection model; and
render the target projection model after homogeneous transformation, to obtain the target image.

Optionally, the rendering module 340 is further configured to:
extract two components corresponding to the screen coordinate system from the vertex coordinates of the target projection model after homogeneous transformation; and
render the 3D virtual model to the screen coordinate system based on the two components, to obtain the target image.

The image rendering apparatus provided in this embodiment of the present disclosure can perform the image rendering method provided in any embodiment of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

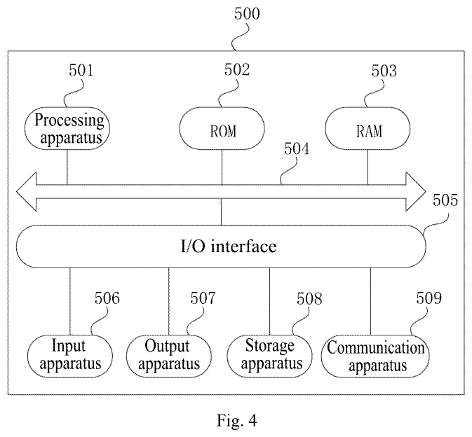

FIG. 4 is a schematic diagram of a structure of an electronic device according to an embodiment of the present disclosure. Reference is made to FIG. 4 below, which is a schematic diagram of a structure of an electronic device (such as a terminal device or a server in FIG. 4) 500 suitable for implementing the embodiments of the present disclosure. The terminal device in this embodiment of the present disclosure may include, but is not limited to, a mobile terminal such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and a fixed terminal such as a digital TV and a desktop computer. The electronic device shown in FIG. 4 is merely an example, and shall not impose any limitation on the function and scope of use of the embodiments of the present disclosure.

As shown in FIG. 4, the electronic device 500 may include a processing apparatus (e.g., a central processing unit or a graphics processing unit) 501 that may perform a variety of appropriate actions and processing in accordance with a program stored in a read-only memory (ROM) 502 or a program loaded from a storage apparatus 508 into a random-access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 4 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 509, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the image rendering method according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium having stored there on a computer program that, when executed by a processor, causes the image rendering method provided in the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a Hypertext Transfer Protocol (HTTP), and may be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: obtain a 3D virtual model, and initial transformation information input by a user, where the 3D virtual model is composed of a plurality of vertices, and the transformation information includes at least one of scaling information, rotation information, and translation information; perform transformation of a first projection type and transformation of a second projection type on the 3D virtual model respectively based on the initial transformation information, to obtain a first projection model and a second projection model; and control the 3D virtual model to translate in a screen coordinate system based on the first projection model and the second projection model, to obtain a target image.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, an image rendering method is provided. The method includes:
obtaining a 3D virtual model and initial transformation information input by a user, where the 3D virtual model is composed of a plurality of vertices, and the transformation information includes at least one of scaling information, rotation information, and translation information;
performing transformation of a first projection type and transformation of a second projection type on the 3D virtual model respectively based on the initial transformation information to obtain a first projection model and a second projection model; and
controlling the 3D virtual model to translate in a screen coordinate system based on the first projection model and the second projection model to obtain a target image.

Further, the first projection type is perspective projection, and the performing transformation of a first projection type on the 3D virtual model based on the initial transformation information, to obtain a first projection model includes:
obtaining perspective projection information and view information, where the perspective projection information represents a perspective transformation relationship from a camera coordinate system to the screen coordinate system, and the view information represents a transformation relationship from a world coordinate system to the camera coordinate system, and the camera coordinate system is a coordinate system where a virtual camera for rendering is located, and the world coordinate system is a coordinate system where the 3D virtual model is located;
adjusting the translation information in the initial transformation information to obtain first transformation information; and
performing perspective projection transformation on the 3D virtual model based on the first transformation information, the perspective projection information, and the view information to obtain a perspective projection model.

Further, the adjusting the translation information in the initial transformation information, to obtain first transformation information includes:
determining a first adjustment amount based on the translation information in the initial transformation information and a first set value; and
adjusting the translation information based on the first adjustment amount to obtain the first transformation information.

Further, the second projection type is orthogonal projection, and the performing transformation of a second projection type on the 3D virtual model based on the initial transformation information to obtain a second projection model includes:
obtaining orthogonal projection information and view information, where the orthogonal projection information represents an orthogonal transformation relationship from the camera coordinate system to the screen coordinate system, and the view information represents a transformation relationship from the world coordinate system to the camera coordinate system, and the camera coordinate system is a coordinate system where the virtual camera for rendering is located, and the world coordinate system is a coordinate system where the 3D virtual model is located;
adjusting the rotation information and the scaling information in the initial transformation information to obtain second transformation information; and
performing orthogonal projection transformation on the 3D virtual model based on the second transformation information, the orthogonal projection information, and the view information to obtain an orthogonal projection model.

Further, the adjusting the rotation information and the scaling information in the initial transformation information to obtain second transformation information includes:
determining a second adjustment amount based on the rotation information in the initial transformation information and a second set value;
determining a third adjustment amount based on the scaling information in the initial transformation information and a third set value; and
adjusting the rotation information based on the second adjustment amount, and adjusting the scaling information based on the third adjustment amount, to obtain the second transformation information.

Further, the controlling the 3D virtual model to translate in a screen coordinate system based on the first projection model and the second projection model to obtain a target image includes:
fusing the first projection model and the second projection model to obtain a target projection model; and
rendering the target projection model, to obtain the target image.

Further, the fusing the first projection model and the second projection model, to obtain a target projection model includes:
extracting vertex coordinates from the first projection model; and
performing linear superimposition on the second projection model and the first projection model based on the vertex coordinates, to obtain the target projection model.

Further, vertex coordinates of the target projection model are represented by a four-dimensional coordinate, including: a first component, a second component, a third component, and a fourth component. The rendering the target projection model, to obtain the target image includes:
performing homogeneous transformation on the vertex coordinates of the target projection model; and
rendering the target projection model after homogeneous transformation to obtain the target image. Further, the rendering the target projection model after homogeneous transformation, to obtain the target image includes:
extracting two components corresponding to the screen coordinate system from a vertex coordinate of the target projection model after homogeneous transformation; and
rendering the 3D virtual model to the screen coordinate system based on the two components, to obtain the target image.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An image rendering method, comprising:
obtaining a three dimensional (3D) virtual model and receiving initial transformation information input by a user, wherein the 3D virtual model is composed of a plurality of vertices, and the initial transformation information comprises at least one selected from a group consisting of: scaling information, rotation information, and translation information;
performing transformation of a first projection type and transformation of a second projection type on the 3D virtual model respectively based on the initial transformation information to obtain a first projection model and a second projection model; and
controlling the 3D virtual model to translate in a screen coordinate system based on the first projection model and the second projection model to obtain a target image.

2. The method according to claim 1, wherein the first projection type is perspective projection, and the performing transformation of a first projection type on the 3D virtual model based on the initial transformation information to obtain a first projection model comprises:
obtaining perspective projection information and view information,
adjusting the translation information in the initial transformation information to obtain first transformation information; and
performing perspective projection transformation on the 3D virtual model based on the first transformation information, the perspective projection information, and the view information to obtain a perspective projection model as the first projection model.

3. The method according to claim 2, wherein the adjusting the translation information in the initial transformation information to obtain first transformation information comprises:
determining a first adjustment amount based on the translation information in the initial transformation information and a first set value; and
adjusting the translation information based on the first adjustment amount to obtain the first transformation information.

4. The method according to claim 1, wherein the second projection type is orthogonal projection, and the performing transformation of a second projection type on the 3D virtual model based on the initial transformation information to obtain a second projection model comprises:
obtaining orthogonal projection information and view information,
adjusting the rotation information and the scaling information in the initial transformation information to obtain second transformation information; and
performing orthogonal projection transformation on the 3D virtual model based on the second transformation information, the orthogonal projection information, and the view information to obtain an orthogonal projection model as the second projection model.

5. The method according to claim 4, wherein the adjusting the rotation information and the scaling information in the initial transformation information to obtain second transformation information comprises:
determining a second adjustment amount based on the rotation information in the initial transformation information and a second set value;
determining a third adjustment amount based on the scaling information in the initial transformation information and a third set value; and
adjusting the rotation information based on the second adjustment amount, and adjusting the scaling information based on the third adjustment amount, to obtain the second transformation information.

6. The method according to claim 1, wherein the controlling the 3D virtual model to translate in a screen coordinate system based on the first projection model and the second projection model to obtain a target image comprises:
fusing the first projection model and the second projection model to obtain a target projection model; and
rendering the target projection model to obtain the target image.

7. The method according to claim 6, wherein the fusing the first projection model and the second projection model to obtain a target projection model comprises:
extracting vertex coordinates from the first projection model; and
performing linear superimposition on the second projection model and the first projection model based on the vertex coordinates, to obtain the target projection model.

8. The method according to claim 6, wherein each vertex coordinate of the target projection model is represented by a four-dimensional coordinate, the four-dimensional coordinate comprises: a first component, a second component, a third component, and a fourth component; and the rendering the target projection model to obtain the target image comprises:
performing homogeneous transformation on the vertex coordinates of the target projection model; and
rendering the target projection model after homogeneous transformation to obtain the target image.

9. The method according to claim 8, wherein the rendering the target projection model after homogeneous transformation to obtain the target image comprises:
extracting two components corresponding to the screen coordinate system from a vertex coordinate of the target projection model after homogeneous transformation; and
rendering the 3D virtual model to the screen coordinate system based on the two components to obtain the target image.

10. (canceled)

11. An electronic device, comprising:
one or more processors; and
a storage apparatus, configured to store one or more programs,
wherein the one or more programs, when executed by the one or more processors, cause the one or more processors to implement an image rendering method, and the method comprises:
obtaining a three dimensional (3D) virtual model and receiving initial transformation information input by a user, wherein the 3D virtual model is composed of a plurality of vertices, and the initial transformation information comprises at least one selected from a group consisting of: scaling information, rotation information, and translation information;
performing transformation of a first projection type and transformation of a second projection type on the 3D virtual model respectively based on the initial transformation information to obtain a first projection model and a second projection model; and
controlling the 3D virtual model to translate in a screen coordinate system based on the first projection model and the second projection model to obtain a target image.

12. A non-transitory storage medium comprising computer-executable instructions, wherein the computer instructions, when executed by a computer processor, are used to perform an image rendering method, and the method comprises:
obtaining a three dimensional (3D) virtual model and receiving initial transformation information input by a user, wherein the 3D virtual model is composed of a plurality of vertices, and the initial transformation information comprises at least one selected from a group consisting of: scaling information, rotation information, and translation information;
performing transformation of a first projection type and transformation of a second projection type on the 3D virtual model respectively based on the initial transformation information to obtain a first projection model and a second projection model; and
controlling the 3D virtual model to translate in a screen coordinate system based on the first projection model and the second projection model to obtain a target image.

13. The electronic device according to claim 11, wherein the first projection type is perspective projection, and the performing transformation of a first projection type on the 3D virtual model based on the initial transformation information to obtain a first projection model comprises:
obtaining perspective projection information and view information,
adjusting the translation information in the initial transformation information to obtain first transformation information; and
performing perspective projection transformation on the 3D virtual model based on the first transformation information, the perspective projection information, and the view information to obtain a perspective projection model as the first projection model;
taking the second motion frame as a new first motion frame and taking the second trailing picture as a new first trailing picture, and returning to continue performing a capturing operation for obtaining a second motion frame.

14. The electronic device according to claim 13, wherein the adjusting the translation information in the initial transformation information to obtain first transformation information comprises:
determining a first adjustment amount based on the translation information in the initial transformation information and a first set value; and
adjusting the translation information based on the first adjustment amount to obtain the first transformation information.

15. The electronic device according to claim 11, wherein the second projection type is orthogonal projection, and the performing transformation of a second projection type on the 3D virtual model based on the initial transformation information to obtain a second projection model comprises:
obtaining orthogonal projection information and view information,
adjusting the rotation information and the scaling information in the initial transformation information to obtain second transformation information; and
performing orthogonal projection transformation on the 3D virtual model based on the second transformation information, the orthogonal projection information, and the view information to obtain an orthogonal projection model as the second projection model.

16. The electronic device according to claim 15, wherein the adjusting the rotation information and the scaling information in the initial transformation information to obtain second transformation information comprises:
determining a second adjustment amount based on the rotation information in the initial transformation information and a second set value;
determining a third adjustment amount based on the scaling information in the initial transformation information and a third set value; and
adjusting the rotation information based on the second adjustment amount, and adjusting the scaling information based on the third adjustment amount, to obtain the second transformation information.

17. The electronic device according to claim 11, wherein the controlling the 3D virtual model to translate in a screen coordinate system based on the first projection model and the second projection model to obtain a target image comprises:
fusing the first projection model and the second projection model to obtain a target projection model; and
rendering the target projection model to obtain the target image.

18. The electronic device according to claim 17, wherein the fusing the first projection model and the second projection model to obtain a target projection model comprises:
extracting vertex coordinates from the first projection model; and
performing linear superimposition on the second projection model and the first projection model based on the vertex coordinates, to obtain the target projection model.

19. The electronic device according to claim 17, wherein each vertex coordinate of the target projection model is represented by a four-dimensional coordinate, the four-dimensional coordinate comprises: a first component, a second component, a third component, and a fourth component; and the rendering the target projection model to obtain the target image comprises:
performing homogeneous transformation on vertex coordinates of the target projection model; and
rendering the target projection model after homogeneous transformation to obtain the target image.

20. The electronic device according to claim 19, wherein the rendering the target projection model after homogeneous transformation to obtain the target image comprises:
extracting two components corresponding to the screen coordinate system from a vertex coordinate of the target projection model after homogeneous transformation; and
rendering the 3D virtual model to the screen coordinate system based on the two components to obtain the target image.

21. The non-transitory storage medium according to claim 12, wherein the first projection type is perspective projection, and the performing transformation of a first projection type on the 3D virtual model based on the initial transformation information to obtain a first projection model comprises:
obtaining perspective projection information and view information,
adjusting the translation information in the initial transformation information to obtain first transformation information; and
performing perspective projection transformation on the 3D virtual model based on the first transformation information, the perspective projection information, and the view information to obtain a perspective projection model as the first projection model.
